(19) United States
(12) Patent Application Publication
(10) Pub. No.: US 2003/0128426 A1
(43) Pub. Date: Jul. 10, 2003

(54) Digital camera binoculars

(76) Inventor: Peter Hammond, Rochester, NY (US)

Correspondence Address: Neal L. Slifkin, HARRIS BEACH LLP, 99 Garnsey Road, Pittsford, NY, 14534, US

(21) Appl. No.: 10/040,591

(22) Filed: Jan. 4, 2002

(51) Int. Cl. G02B 23/00; G02B 27/02

(52) U.S. Cl. 359/407; 359/409; 359/431; 359/482

(57) ABSTRACT

Improved binoculars are provided for viewing objects at a distance and for selectively recording a digital image of the objects. The binoculars include first and second monoculars each with an optical lightpath constructed to deliver an image of the object to one eye of the observer. Included within one of the monoculars is a beamsplitter designed to allow a portion of the light in the first optical lightpath to pass to the eye of the observer and to reflect a second portion of the light. The reflected portion of the light is directed to a digital image sensor and recording device. The other monocular includes compensating optics, such as a second beamsplitter, to alter the image to correct for the refraction and decrease in light intensity caused by the beamsplitter in the first light path. The second monocular does not include an image sensor and does not include an image recording device.

### 1. FIELD OF INVENTION

The present invention relates to binoculars, and more specifically to binoculars which include a digital camera for recording the images viewed through one of the monoculars in the binoculars.

### 2. BACKGROUND OF THE INVENTION

A pair of conventional binoculars is basically two small refracting telescopes or monoculars held together by a frame that produce a stereoscopic or three-dimensional view. Each refracting telescope has an optical path defined through an objective lens, a pair of prisms and an eye piece. The diameter of the objective lens determines the light-gathering power. In some binoculars, the two objective lenses are further apart than the eyepieces, which enhances stereoscopic vision. Functioning as a magnifier, the eyepiece forms a large virtual image which becomes the object for the eye itself and thus forms the final image on the retina.

Various improvements have been made to binoculars over the years, including the addition of digital recording and playback means with the binoculars. One such patent, U.S. Pat. No. 5,581,399 issued to Abe, the disclosure of which is incorporated by reference, includes, in each monocular in the pair of binoculars, an image sensor, a first optical system, a second optical system and a display so that the binoculars can selectively view optically projected images and electronically reproduced images that are stored by the binoculars. The display is a flat panel type liquid crystal display which appears transparent when optically projected images are viewed. When electronically reproduced images are to be viewed, a back light is pivoted behind the display from the eyepiece side. While such binoculars offer the advantage of storage and playback of images the number of components increases the complexity of the design and decreases the use of the battery, thereby decreasing battery life. Further, because the display is located in the optical path, even though it appears transparent when the optical path is being used, the image quality is degraded, and brightness is lost, due to placement of the display in the optical path.

Another patent, U.S. Pat. No. 5,963,369 issued to Steinthal, et al., the disclosure of which is incorporated by reference, discloses a hand-held 3-D imaging system that can be used for outdoor viewing and for digital photography. A pair of hand-held prism binoculars is fitted with an integrated stereoscopic imaging system that can record and playback one or more images seen through the optics of the pair of binoculars. The pair of binoculars has two refracting telescopes mounted on a single frame, and each of the refracting telescopes has an optical path defined through an objective lens, a pair of prisms and an eye piece. Imaging sensors and emitters are placed perpendicular to each optical path of the binocular system so that one or more images can be converted to an electronic record signal during a record mode, electronically stored internally and/or externally and then converted back to one or more images from an electronic playback signal during a playback mode. This imaging system also has many unnecessary components and is expensive to manufacture. Accordingly, there is a need for improved, simplified stereoscopic imaging systems, especially for compact, inexpensive systems which are capable of capturing high quality images while eliminating components used in such systems in the past.

### SUMMARY OF THE INVENTION

The present invention relates to binoculars for viewing objects at a distance and for selectively recording a digital image of the objects. The binoculars include a first monocular which has an optical lightpath constructed to deliver an image of the object to one eye of the observer. A second monocular has an optical lightpath constructed to deliver an image of the object to the other eye of the observer. These two monoculars are joined together to form a pair of binoculars. Preferably, each monocular is attached to a body which houses components of a recording device. The positions of the monoculars relative to each other may be adjusted to accommodate the spacing between the eyes of the observer. The adjustment may be made by a pivotal connection or by sliding connection of one of the monoculars to the body. Inside each monocular are conventional optics designed to magnify the objects to be observed. Also included within one of the monoculars is a beamsplitter placed in the optical lightpath. This beamsplitter is designed to transmit a portion of the light in the first optical lightpath to the eye of the observer and to reflect second portion of the light. The reflected portion of the light is directed to a digital image recording device which receives the light and records the image contained in the light. The other monocular includes compensating optics disposed in the second optical lightpath to alter the image to correct for the refraction and decrease in light intensity caused by the beamsplitter in the first light path. Preferably, the compensating optics would include a second beamsplitter, which alters the light in the same manner as the first beamsplitter. Alternatively, the compensating optics could include a glass element with the same light altering characteristics as the beamsplitter. The second monocular does not include an image sensor and does not include an image recording device associated with the sensor. The elimination of these components, makes for a less complex design and increases the battery life of the batteries used in the device.

The digital image recording device could include a charge coupled device (CCD) or a complementary metal oxide semiconductor (CMOS). The digital image recording device could be designed to record still images or video images. The image may be recorded on memory attached to the recording device or on removable memory, such as memory sticks, memory cards, memory disks, or the like.

The digital binoculars can function as a still digital camera by using close-up optics to allow for viewing and image capture of scenes closer than what would normally be out of focus for the binoculars. A close-up lens can be placed on the entrance of the optics leading to the image sensor or a lens can be placed in front of both monoculars. Alternatively, one lens could be used and a cover could be placed over the monocular which does not include the image sensor.

Binoculars also have a range of object distances over which the image will be in focus. This could be, for instance, 1,000 ft to infinity. When the binoculars are used visually, there are two mechanisms by which objects can be brought in to focus for a particular object distance. The first is by adjusting the axial distance between the objective and eyepiece lenses. If this range is exhausted due to a very close object distance (and possibly the extreme myopia or hyperopia of the user), the user can use eye accommodation to further improve the focus. In both cases, the user inherently uses visual images to assess this quality.

Digital binoculars are designed to be in focus (providing high image quality) over a certain object distance range. In the case where a beamsplitter is used after the objective to divide light between the eyepiece and the digital camera lens/sensor, the optical path distance from the objective to the digital camera lens and likewise to the sensor are pre-set such that objects at, for example, 100 meters to infinity are sufficiently in focus on the sensor. For these far away distances, the relationship between object distance and focus error is very insensitive.

If, however, the object is closer than 100 meters, for example, the digital image will be severely out of focus. By viewing the image on a digital display, the user may know the image is out of focus. Alternatively, the binoculars could have an auto focus indicator to alert the user that the image is out of focus.

Close up lenses are typically used in addition to camera lenses when the object of interest is too close and thus outside the focus range for which the camera lens is designed. Close up lenses are available in increments of power, such as 0.5, 1.0, or 2.0 diopters. The user attaches the close up lens to the outer end of the camera lens where there is an adapter for accessories such as filters and lens caps. The close up lens changes the focal length of the entire optical path such that the image can now be brought into focus on the digital sensor.

The user would choose a close up lens power depending on the object distance. For objects which are distant, but close enough that the camera cannot completely focus on them, the user selects a low power close up lens, such as 0.5 diopters. For closer objects, the user selects a high power close up lens, such as 4.0 diopters. At extremely close distances, the lens design will be so far from optimized that a macro lens would be needed.

If the binoculars were to have an attachment capability on the fronts of both objectives, close up lenses could be used in the same way they are for cameras. For example, for a moderately close object, 1.0 diopter close up lenses could be attached to each of the two objective lenses. This shifts the focus range such that it is back within the range of the objective to eyepiece lens distance adjustment. The user can then re-adjust this distance to fine tune the image quality. Once the most ideal power close up lens is attached, the digital image will be in much better focus. However, since the choice of close-up lenses is incremental, and the relationship between object distance and focus error is now very sensitive, fine tuning the focus may be needed to bring the image into best focus for recording by the image sensor and related electronics. To focus the binoculars, first the focus is adjusted for each eye. Next, the focus must be adjusted for the image sensor. Although the focus for the eyes and image sensor could be a manual focus, the use of automatic focusing could be employed. Such automatic focusing is known in the digital camera art. After the image is recorded, it may be desirable to transfer the image to another electronic device. Preferably, the binocular includes an electrical connection for transferring the recorded image to another electronic device. The connection could be of any standard type, such as a USB connection, a serial connection, a parallel connection, or an IEEE 1394 (FireWire) connection, among others. Optionally, the device could be designed to deliver images to a personal digital assistant, such as a Palm Pilot, manufactured by Palm, Inc. of Santa Clara, Calif. Alternatively, the image could be delivered wirelessly to a display device or to a computer.

Other desirable features could be built into the device such as electronic or mechanical image stabilizing features to prevent movement of the image under high magnification. Additional features, such as sound recording and recording of location using the global positioning satellite system could be incorporated into the binoculars.

These and other objects of the present invention will become more readily appreciated and understood from a consideration of the following detailed description of the preferred embodiment when taken together with the accompanying drawings, in which:

### BRIEF DESCRIPTION OF THE DRAWINGS

FIG. 1 is a perspective view of the digital binoculars of the present invention;

FIG. 2 is a transparent perspective view of the invention of FIG. 1;

FIG. 3 is a simplified diagrammatic view of a monocular;

FIG. 4 is a simplified diagrammatic view of two monoculars;

FIG. 5 is a simplified diagrammatic view of two monoculars having an alternative prism configuration;

FIG. 6 is a simplified diagrammatic view of one embodiment of the present invention;

FIG. 7 is a simplified diagrammatic view of another embodiment of the present invention;

FIG. 8 is a simplified diagrammatic view of the embodiment of FIG. 7 showing the mirror in a second position;

FIG. 9 is a simplified diagrammatic view of a third embodiment of the present invention;

FIG. 10 is a simplified diagrammatic view of the embodiment of FIG. 9 showing the mirror in a second position;

FIG. 11 is a simplified diagrammatic view of fourth embodiment of the present invention;

FIG. 12 is a simplified diagrammatic view of an embodiment of the present invention showing the digital binoculars adapted for close-up photography; and

FIG. 13 is a block diagram of the electronic components of the present invention.

### DETAILED DESCRIPTION OF THE PREFERRED EMBODIMENT

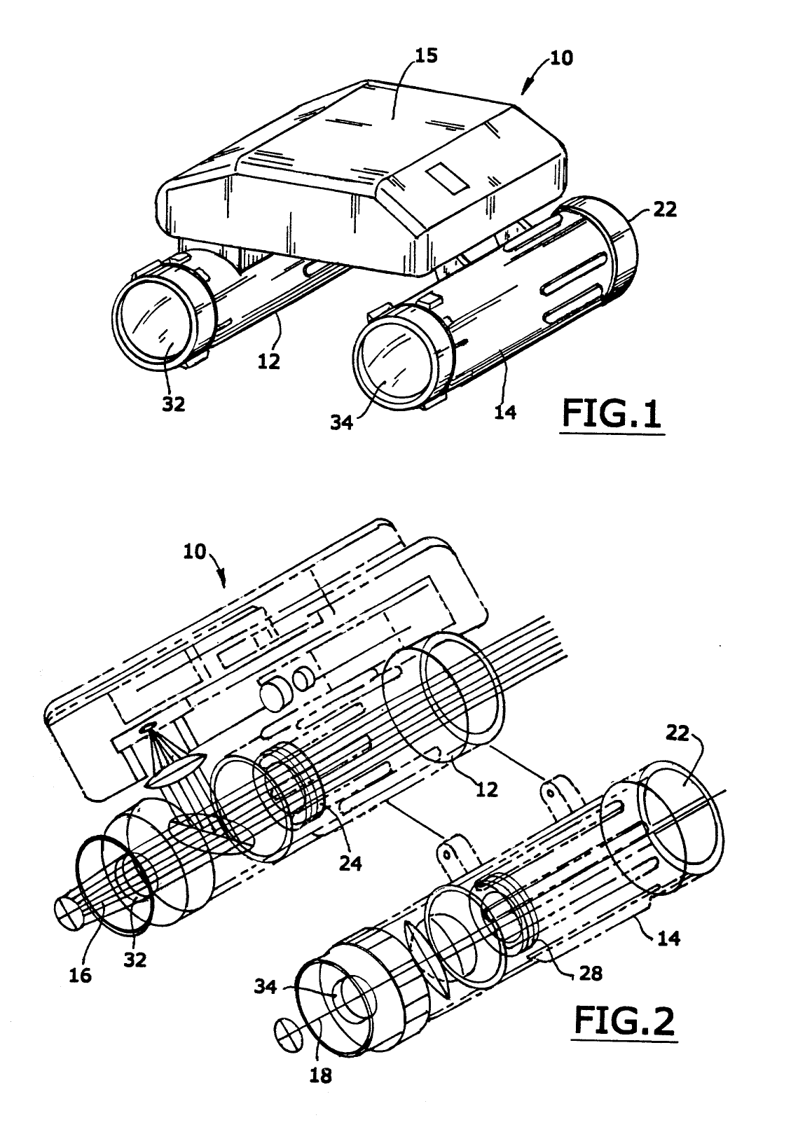

As shown in FIGS. 1 and 2, the pair of binoculars 10 is basically two small refracting telescopes or monoculars 12 and 14 attached to a housing 15 that produce a stereoscopic or three-dimensional view. Each refracting monocular 12 and 14 has an optical path 16 and 18 defined through an objective lens 20 and 22, a pair of prisms shown as 24 in path 16 and 28 in path 18, and eyepieces 32 and 34. The diameter of the objective lens 20 and 22 determines the light-gathering power. The larger the diameter of the objective lens, the more light will be collected, resulting in a brighter image or sufficient brightness for low light scenes. Preferably, the two objective lenses 20 and 22 are further apart than the eyepieces 32 and 34, which enhances stereoscopic vision. Functioning as a magnifier, the eyepieces 32 and 34 form a large virtual image which becomes the object for the eye itself and thus forms the final image on the retina.

After passing through the focus, the beam is recollimated by the eyepieces 32 and 34 providing parallel rays to the eye for final focusing. The ratio of the two focal lengths (for the objective lens and the eyepieces) gives the angular magnification of the instrument. That is, if the objective focal length is 100 mm, and the eyepiece focal length is 10 mm, the instrument angular magnification is 10×. The object will appear 10 times larger to the viewer than it would with the naked eye.

The exit pupil and the field of view properties are determined by the choice of objective and eyepiece parameters, as is known in the art. The diameter of the exit pupil should be matched appropriately to the diameter of the viewer's eye pupil. This allows all rays collected by the objective to enter the eye. The position of the exit pupil must be sufficiently behind the eyepiece to provide sufficient eye relief for the viewer. When the viewer can place the pupil of his eye at the exit pupil, rays from all fields of view will enter the eye. The field of view of a set of binoculars is limited by the apertures and aberration correction of the eyepiece lenses.

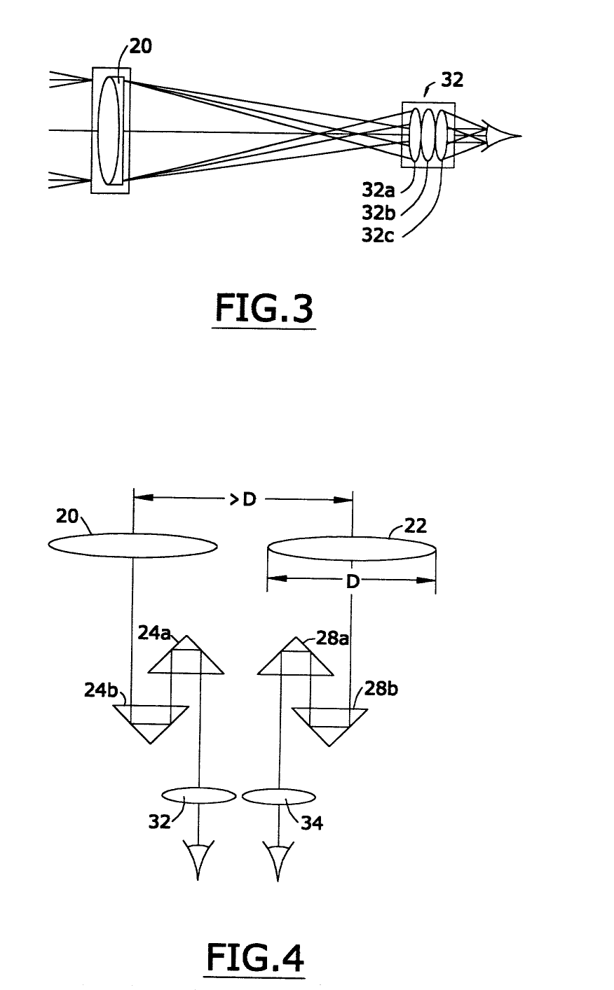

The prisms 24 and 28 are elements placed between the objective and eyepiece lenses to perform one or more functions. All visual binoculars require an inversion of the image provided by the lens system described above. If this is not done, the image will appear upside-down to the viewer. Additionally, for binocular instruments with very high power and/or very large objectives, the prism(s) provide a method of “folding” the beams to satisfy dimensional constraints. Referring to FIG. 3, objective lenses usually consist of two lens elements in an achromatic doublet configuration. For small and/or inexpensive binoculars, there may only be a single element 20. For very large, high magnification, and/or low light level instruments, three or more lenses may be required to achieve good aberration correction.

The eyepiece lens assembly 32 is much more complicated than the objective lens assembly because it operates in the region where the ray angles are steeper, and because the design must pay particular attention to eye relief and field of view. The number of individual lenses that make up the eyepiece assembly 32 can vary from two (for an inexpensive and/or low magnification instrument) to several for a high-performing instrument. Three are shown in FIG. 3 for illustration purposes, as 32a, 32b, and 32c.

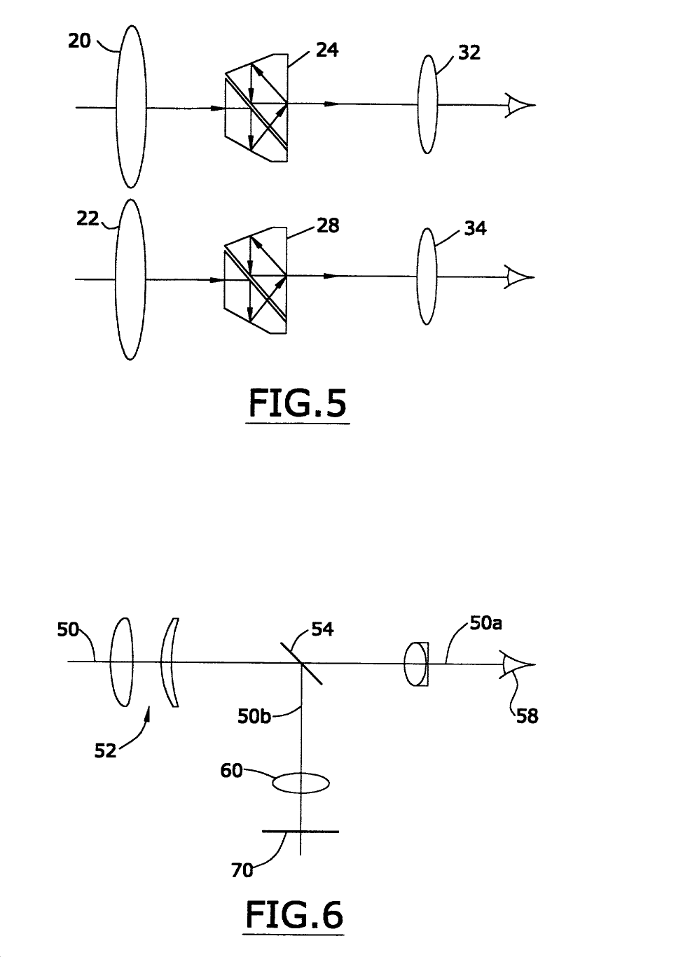

Turning to FIGS. 4 and 5, there are two basic types of prisms that are used for binoculars, depending on the parameters of the instrument. For very high magnification and/or low light level conditions (FIG. 4), the diameter of the objective lens 20 and 22 must be very large. The center to center distance between the two objectives can be no less than the objective diameter D, thus exceeding the interpupillary distance (roughly 7 cm) in many cases. A two prism system is used in these cases so that the two beams can be folded closer to one another, thus aligning the beams to the eyes. These right angle prisms 24a, 24b, 28a and 28b in FIG. 4 are called Porro prisms. For smaller objectives (FIG. 5), a one-element prism 24 can be used because each monocular can be used in-line. A Pechan prism is ideal for this case in that it will invert the upside-down image using a compact configuration.

Turning to the digital recording features of the present invention, reference is made to FIGS. 6 through 11 which are simplified diagrams of the binocular optics. It will be understood by those of ordinary skill in the art that the digital recording features could be used with any number of variations of binocular optics. In FIG. 6, after the light 50 enters through the objective optics 52 it is split by a beamsplitter 54 before passing through one or more additional optical components. The beamsplitter 54 takes a portion of the light 50b and reflects it at an angle relative to the incident angle. The remainder of the light 50a continues toward the eye 58 of the observer. The beamsplitter 54 causes the light 50a to reflect off axis, and reduces the intensity of the light which reaches the eye. Without compensating optics in the second monocular 14 (FIG. 2), the images appearing to each eye of the observer would be distorted. The light 50b passes through an imaging lens 60 and is directed to a solid-state imaging sensor shown generally as 70.

The second monocular 14 includes compensating optics 26 the light in the same manner as the beamsplitter 54. In its simplest form, the present invention includes a second beamsplitter 84 to cause an equal reflection of the light as is caused by the beamsplitter 54. The portion of the light 51 which is split off and directed at a 90 degree angle to the light path is absorbed by the wall 62 of the monocular. Although the compensating optics split the light, the light is not directed to a second image sensor. The elimination of the second image sensor, and second image recording electronics, represents an improvement over the prior art. By eliminating the second image sensor and recording electronics, the manufacturing costs are greatly reduced, yet the binocular digital camera is still capable of producing high quality digital images.

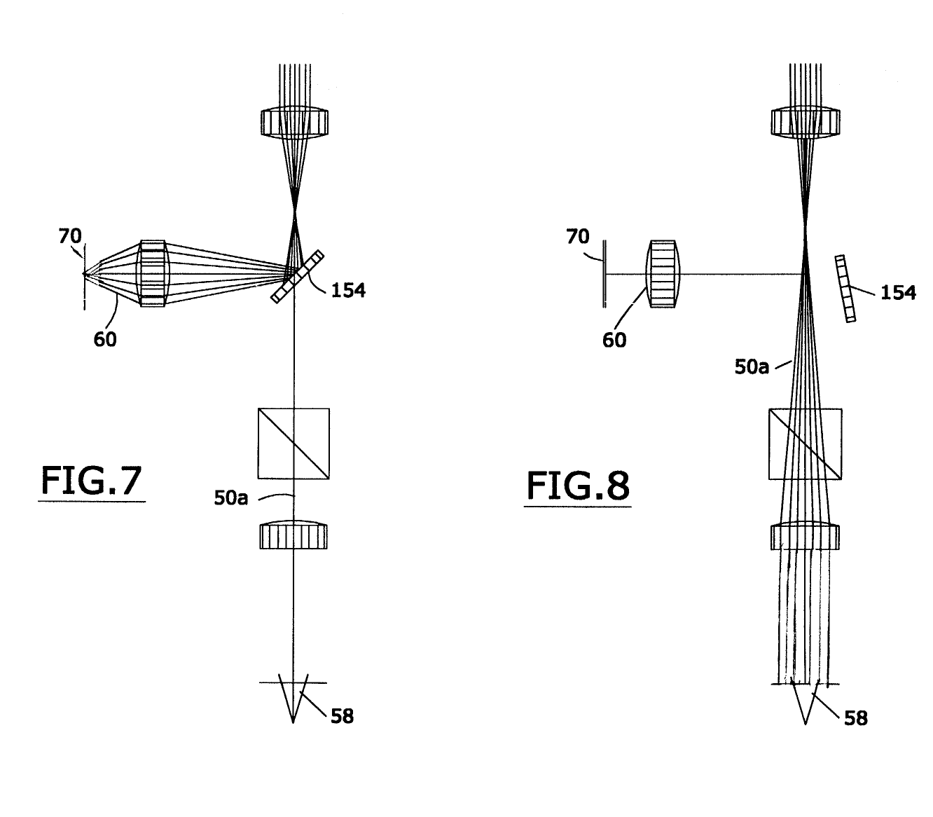

The embodiment of FIGS. 7-8 are similar to the one shown in FIG. 6, except that the beamsplitter 54 has been replaced with a reflex mirror 154. The reflex mirror 154 may be pivoted into (FIG. 7) and out of (FIG. 8) the light path 50a, to direct light to the image sensor 70 and the eye 58, respectively.

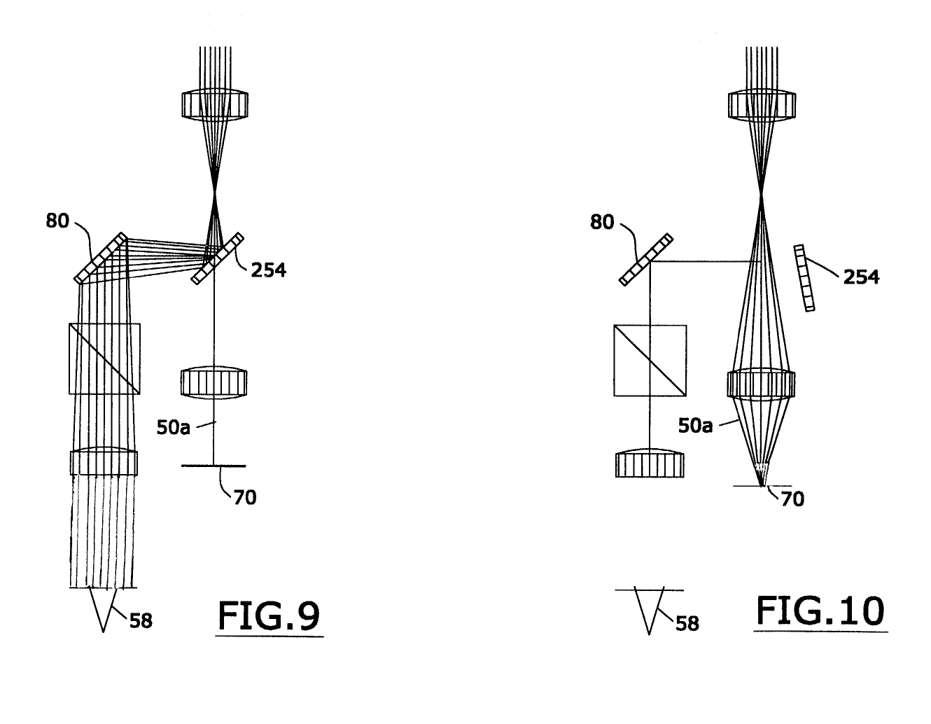

The embodiments in FIGS. 9-11 are similar to those in FIGS. 6-8. However, in FIGS. 9 and 10, the monocular has a second mirror 80. When the first mirror 254 is in the lightpath 50(a), the image is directed to the eye 58. When the first mirror 254 is not in the lightpath (FIG. 10), the light is directed to the image sensor 70.

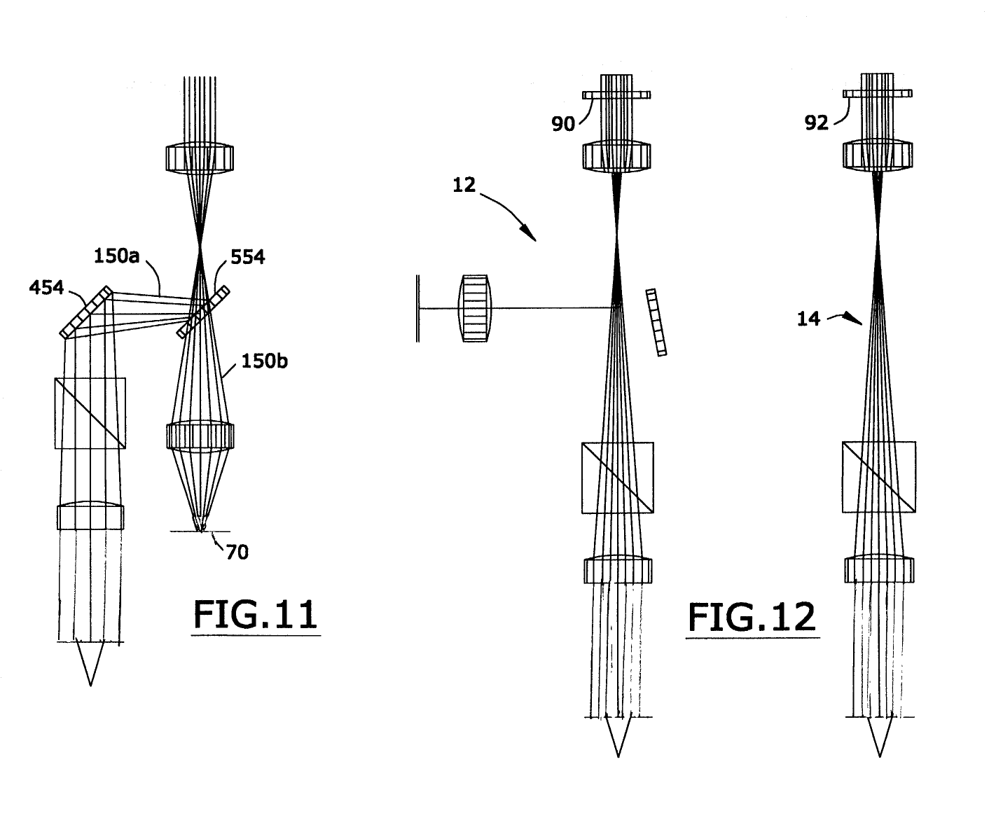

The embodiment of FIG. 11 includes a beamsplitter 554 similar to that of FIG. 6. However, the direct path of the light 150b is to the image sensor 70 and the light to the eye 150a is bent an angle and directed to a mirror 454, which reflects the light to the eye 58.

In FIG. 12, the binoculars have been modified to allow for close-up still photography. A close-up lens 90 is provided to allow the monocular 12 to focus on objects which are too close for the binocular optics to properly focus. The second monocular 14 is provided with a cover 92, because it is not necessary to look through both monoculars when taking close-up digital photographs.

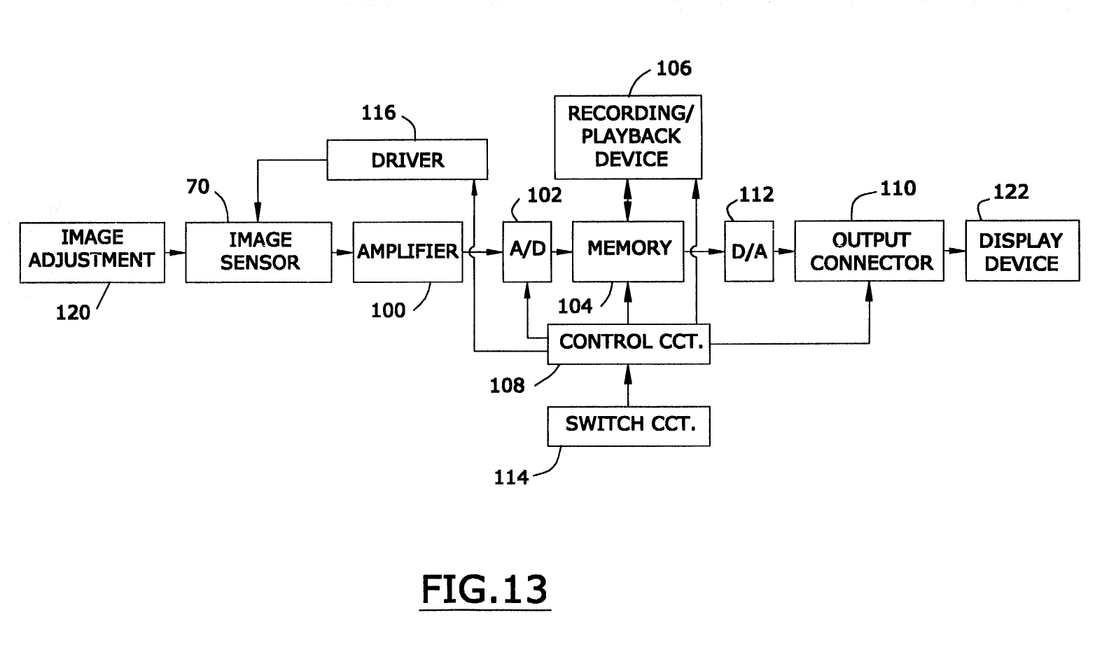

The digital binoculars require an electronic imaging sensor and supporting electronic circuitry to capture and manipulate the digital image. This circuitry is shown in FIG. 13. The solid-state imaging sensor 70 converts one or more images into an electronic record signal. The image sensor 70 is a solid state device such as a charge coupled device (CCD) or a complementary metal oxide semiconductor (CMOS) photo array, although any other solid-state imaging sensor could also be used.

The image recording device used with the present invention could be of any conventional type and need not be described in great detail. Referring to FIG. 13, generally, an amplifier 100 receives and amplifies the output signal from the image sensor 70. An A/D converter 102 converts the analog signal from the amplifier 100 to a digital signal. A memory device 104 stores the digital signal. A recording/playback device 106 records the digital signal onto a recording medium and/or reads out recorded images to a D/A converter, which converts the signal from digital to analog. An output connector 110 receives the analog signal from the D/A converter 112. Cables (not shown) may be connected to the output connector 110 to transmit the image to a display or other device 122. A control circuit 108 controls the other circuits in the camera and a switch circuit 114 controls the actuation of the camera. A driver 116 which drives the image sensor 70. Image adjustment electronics 120 may be provided to stabilize or alter the image.

Accordingly, the present invention has been described with some degree of particularly directed to the preferred embodiment of the present invention. It should be appreciated, though, that the present invention is defined by the following claims construed in light of the prior art so that modifications or changes may be made to the preferred embodiment of the present invention without departing from the inventive concepts contained herein.

What is claimed is:

1. An apparatus for viewing by an observer objects at a distance and selectively recording a digital image of the objects, comprising:
a first monocular having a first optical lightpath constructed to deliver an image of the objects to one eye of the observer;
a second monocular having a second optical lightpath constructed to deliver an image of the objects to the other eye of the observer;
a first beamsplitter placed in the optical lightpath of the first monocular, said first beamsplitter constructed to allow a portion of the light in the first optical lightpath to pass to the eye of the observer and to reflect a second portion of the light;
a digital image sensor constructed to receive the second portion of the light and to record the image contained in the second portion of the light;
compensating optics disposed in the second optical lightpath to alter the image to correct for alterations made by the first beamsplitter without including a digital image sensor in the second optical lightpath.

2. The apparatus of claim 1 wherein the compensating optics includes a second beamsplitter.

3. The apparatus of claim 1 wherein the digital image sensor includes a charge coupled device.

4. The apparatus of claim 1 wherein the digital image recording device includes a complementary metal oxide semiconductor.

5. The apparatus of claim 1 further including a recording device to record video images.

6. The apparatus of claim 1 further including a digital image recording device to record still images.

7. The apparatus of claim 1 further including a body to which the first monocular and the second monocular are attached.

8. The apparatus of claim 7 wherein the first monocular and the second monocular each have an optical axis and the distance between the optical axes may be adjusted.

9. The apparatus of claim 1 wherein the image is recorded on a removable memory device.

10. The apparatus of claim 1 further including an electrical connection for transferring the recorded image to another electronic device.

11. The apparatus of claim 10 further including a personal digital assistant connected to said electrical connection for displaying the recorded image.

12. The apparatus of claim 11 wherein the electrical connection is a USB port.

13. The apparatus of claim 11 wherein the electrical connection is a serial port.

14. The apparatus of claim 11 wherein the electrical connection is a IEEE 1394 connection.

15. The apparatus of claim 9 wherein the removable storage device is a memory stick.

16. The apparatus of claim 9 wherein the removable storage device is a memory card.

17. The apparatus of claim 9 wherein the removable storage device is a memory disk.

18. The apparatus of claim 1 further including wireless transmission means for transmitting the image to an electronic device.

19. The apparatus of claim 1 further including a display for displaying the image prior to recording of the image by the recording device.

19. The apparatus of claim 1 further including means for stabilizing the image.

20. The apparatus of claim 1 further including means for correcting aberrations in the image.

21. The apparatus of claim 1 further including means for receiving and recording sound.

22. The apparatus of claim 1 further including means for receiving global positioning satellite transmissions and displaying the location of the apparatus.

23. An apparatus for viewing by an observer objects and selectively recording a digital image of the objects, comprising:
a first monocular having a first optical lightpath constructed to deliver an image of the objects to one eye of the observer;
a second monocular having a second optical lightpath constructed to deliver an image of the objects to the other eye of the observer;
a first beamsplitter placed in the optical lightpath of the first monocular, said first beamsplitter constructed to allow a portion of the light in the first optical lightpath to pass to the eye of the observer and to reflect a second portion of the light;
a digital image sensor constructed to receive the second portion of the light and to record the image contained in the second portion of the light; and
a close-up lens adapted to be placed in the first optical lightpath for changing the focus of the first monocular such that images which are relatively near the first monouclar may be focused on the digital image sensor.
